(19) United States
(12) Patent Application Publication
(10) Pub. No.: US 2013/0186827 A1
(43) Pub. Date: Jul. 25, 2013

(54) FORWARD OSMOSIS MEMBRANE BASED ON AN IPC SPACER FABRIC

(71) Applicant: Hydration Systems, LLC, Scottsdale, AZ (US)

(72) Inventors: Isaac V. Farr, Corvallis, OR (US); John R. Herron, Corvallis, OR (US); Upen J. Bharwada, Scottsdale, AZ (US); Tilak Gullinkala, Perrysburg, OH (US)

(73) Assignee: HYDRATION SYSTEMS, LLC, Scottsdale, AZ (US)

(21) Appl. No.: 13/747,381

(22) Filed: Jan. 22, 2013

Related U.S. Application Data
(60) Provisional application No. 61/589,152, filed on Jan. 20, 2012.

(51) Int. Cl. B01D 69/10

(52) U.S. Cl. CPC B01D 69/10
USPC 210/644; 210/486; 427/209

(57) ABSTRACT

A forward osmosis (FO) membrane structure comprising a support based on an integrated permeate channel (IPC) fabric and a forward osmosis membrane embedded in the support is disclosed.

### CROSS-REFERENCE TO RELATED APPLICATION

This application claims priority to U.S. provisional application Ser. No. 61/589,152 filed Jan. 20, 2012, the entire disclosure of which is hereby incorporated by reference.

### FIELD OF THE INVENTION

The invention relates to membranes for use in forward osmosis processes.

### BACKGROUND

Flat-sheet (FS) membranes used in forward osmosis (FO) applications are generally comprised of either a knitted, woven or non-woven fabric imbedded in an asymmetric membrane formed directly through the well-known immersion precipitation route, or a multi-layered TFC membrane including an interfacially polymerized polyamide selective layer on top of a UF polysulfone support structure itself supported on a non-knitted, woven or nonwoven fabric backing. The non-knitted, woven or non-woven and knitted, woven or nonwoven support materials lend strength to the resulting membrane for handling purposes. Once formed, the flat sheet FO membranes can be used to construct useable products based on various geometries, such as spiral wound (SW), plate-and-frame (PF) and pouch elements. In practice, flat sheet SW designs require spacers between adjacent sheets of membrane to provide proper fluid flow dynamics for both feed and draw solutions. Several PF designs that FO applications can take advantage of include A3's use of coarse non-knitted, woven or non-woven permeate drainage layers, Microdyn-Nadir's spacer fabric design, or Kubota's solid plastic construction. In each case, the permeate drainage function is accomplished either through grooves made in a solid plastic support or by incorporating separate spacer fabrics between adjacent membrane sheets; both fabrication techniques use lamination, gluing and/or welding methods to seal these sandwich structures.

### SUMMARY OF THE INVENTION

A forward osmosis (FO) membrane structure comprising a support based on an integrated permeate channel (IPC) fabric and a forward osmosis membrane embedded in the support is disclosed.

### BRIEF DESCRIPTION OF THE DRAWING

FIG. 1 is a simplified illustration of a side view cross section of an example of IPC fabric that may be used in a support for the forward osmosis membrane structure according to an embodiment of the invention.

FIG. 2 is an illustration of a side view cross section of an example of IPC fabric that may be used in a support for the forward osmosis membrane structure according to an embodiment of the invention.

FIG. 3 is an illustration of a side view cross section of a forward osmosis membrane structure made using the IPC fabric of FIG. 2 according to an embodiment of the invention.

### DETAILED DESCRIPTION OF THE INVENTION

### Overview

A forward osmosis membrane structure comprising a support having a forward osmosis membrane impregnated into the outer layers of the support is disclosed herein. The support is comprised of integral permeate channel (IPC) fabric, which consists of a three-dimensional spacer fabric having an upper and a lower fabric layer tied together and spaced apart by monofilament threads.

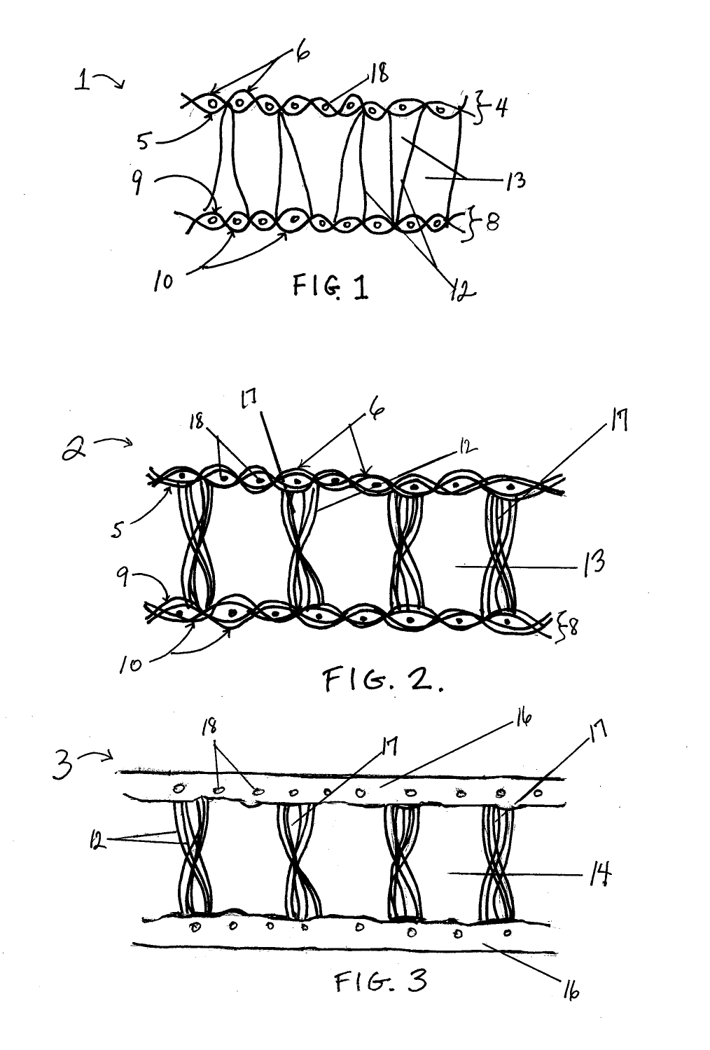

More specifically, the forward osmosis membrane structure has a support comprising an IPC fabric. As illustrated in FIGS. 1 and 2, the IFC fabric support 1, 2 is itself comprised of an upper fabric layer 4 having an inner surface 5 and an outer surface 6; a lower fabric layer 8 having an inner surface 9 and an outer surface 10; and linking monofilament threads 12 disposed between said upper fabric layer and said lower fabric layer and linking the upper fabric layer to the lower fabric layer. In FIG. 1, individual threads are shown, whereas in FIG. 2, multiple threads are bundled together to form bundles 17. A permeate channel 14 is created between the two fabric layers 4, 8 after the FO membranes are formed on the IPC fabric support. FIGS. 1 and 2 illustrate the area 13 between fabric layers 4 and 8 which will become the permeate channel 14. The membranes are not shown in FIGS. 1 and 2. Some of the microfilament threads comprising the upper and lower fabric layers are shown in cross-section 18. FIGS. 1 and 2 are each illustrations of a side view cross sections of different embodiments of the IPC fabric that may be used in the structure of the invention.

FIG. 3 illustrates a side view cross section of a forward osmosis membrane support structure 3 according to a preferred embodiment of the invention. More specifically, FIG. 3 illustrates a polymeric FO membrane 16 formed on each outer surface of the upper and lower fabric layers of the IPC fabric. The FO membrane layers are linked to one another via the bundles 17 of microfilament threads 12 in the support. As shown, the polymeric membrane 16 is embedded within the upper and lower layers of the IPC fabric, so that only some of the microfilaments of the IPC fabric are substantially visible. Those that are substantially visible and therefore shown are the linking bundles 17 of microfilament threads 12 and the microfilament threads 18 that are part of the upper and lower layers of the IPC fabric. The permeate channel 14 that is defined on either side by the upper 4 and lower 8 fabric layers of the IPC fabric is also shown.

The drawings are not to scale, as one of skill in the art would appreciate. Also, while the IPC fabric described herein is discussed in terms of “upper” and “lower” fabric layers, this terminology is for the sake of convenience only. There is no difference in structure or composition of the “upper” and “lower” fabric layers, these layers are interchangeable, and there is no significance to the position of either in space.

The FO osmosis membrane structure's support is provided with a forward osmosis membrane on either side of the IPC fabric, by providing the outer surfaces of the upper and lower fabric layers with an FO membrane. The FO membrane may be based on either a multi-layered thin film composite (TFC) structure or on a single-step asymmetric membrane formation. For example, the FO membrane may be produced by solution casting a pre-membrane polymer formulation on either side of the fabric, followed by immersion precipitation, to effectively yield two selective layers on either side of the fabric, i.e., on the outer surfaces of the upper and lower fabric layers.

The FO membrane structure of the invention is comprised of a support particular fabric, referred to herein as an IPC fabric or an IFC spacer. The support's fabric preferably is made by a knitting operation (e.g., by a Raschel knitting machine). Alternatively, the fabric can be woven or non-woven. An exemplary IPC fabric/IFC spacer for use in the invention is the subject of U.S. Pat. No. 7,862,718 issued to Vlaamse Instelling voor Technologisch Onderzoek (VITO). The entire disclosure of the '718 patent is incorporated herein by reference thereto. The IFC spacer disclosed in the '718 patent is of a knitted, woven or nonwoven spacer fabric, which may have a membrane for reverse osmosis (RO), nanofiltration (NF), ultrafiltration (UF), and microfiltration (MF) placed on either side of the spacer. However, the '718 patent does not have a disclosure or teaching regarding use of the IFC spacer for forward osmosis. Forward osmosis (FO) membranes differ greatly from membranes for other osmotic processes, such as reverse osmosis (RO), nanofiltration (NF), ultrafiltration (UF), and microfiltration (MF) membranes. FO membranes must minimize internal concentration polarization (ICP), which is not a concern with respect to the other aforementioned osmosis processes.

Materials that may be used for the threads or microfilaments in the fabric support in the membrane structure of the invention are as follows: polyester, nylon, polyamide, polyphenylene sulphide, polyethylene and polypropylene. More specific examples are: polyethylene terephthalate (PET), polyamide/nylon (PA), polypropylene (PP), polyethylene (PE), poly(phenylene sulphide) (PPS), polyetherketone (PEK), polyetheretherketone (PEEK), ethylene tetrafluoroethylene (ETFE), monochlorotrifluoroethylene (CTFE), all metals (Fe, Cu, stainless steel etc.). Preferably, the fabric threads or microfilaments are polyester, acrylic, nylon, polypropylene or cotton. Mixtures of threads or microfilaments of any of the foregoing may also be used.

The diameters of the threads or microfilaments are typically in the range of about 50 to about 500 microns. More preferably, the diameter is in the range of about 60 to about 150 microns.

The support structure (the IPC fabric) is preferably about 1 to about 5 mm in thickness. The membranes placed on each side of the support structure are preferably less than about 1 mm in thickness each.

### Process

A membrane is placed on the IPC fabric support structure to form a high water flux, high salt rejection and mechanically robust selecting forward osmosis membrane, by either directly forming the selecting membrane in a single-step by employing immersion precipitation methodologies or by forming a polymeric support structure via immersion precipitation. In an exemplary embodiment, a two-step process is used by using immersion precipitation to form a polysulfone layer, and then forming a coating on the polysulfone layer of interfacially polymerized polyamide.

The role of the porous membrane support structures for RO, NF, UF and MF processes is predominantly for improving the mechanical integrity of the cast membrane. However, in FO processes the porous membrane support strongly influences membrane performance through a phenomenon known as internal concentration polarization (ICP). A properly designed FO membrane will minimize ICP by minimizing S, the structural parameter. This can be achieved by minimizing the tortuosity and the support layer thickness, and maximizing porosity. The so-called S-parameter is based on the attributes of both the polymer support as well as the fabric backing construction.

### IPC Fabric

As a substrate for FO membranes the inventors have determined that the following fabric properties are advantageous to reducing the S-parameter:

Maximize the open area of the two surface fabrics—this allows the development of macrovoids that span the polymer support structure, which yields a membrane with lower tortuosity; the macrovoids are preferably in the range of about 1-50 microns, and more preferably about 5-25 microns.

Minimize the thread fiber diameter used in the outer surfaces of the upper and lower fabric layers—this allows the minimum amount of polymer solution to be deposited while ensuring good mechanical interlocking between the support structure and the fabric backing, which minimized the support layer thickness of the membrane;

Minimize peak-to-valley range of the two surface fabrics—this allows the minimum amount of polymer solution to be deposited while ensuring good mechanical interlocking between the support structure and the fabric backing, which in turn minimizes the support layer thickness of the membrane.

Significantly reduce or substantially eliminate the aberrant surface fibers—this will prevent strike-through with respect to the membrane and lead to the thinnest possible support layer; several methods can be used to eliminate the aberrant surface fibers. For example, corona discharge and calendaring are two preferred methods. An alternative method is melting the aberrant fibers with heat.

Minimize the thickness of the upper and lower layers of the fabric—reducing the thickness of each of these layers results in reducing the support layer thickness, which will lead to a lower S-parameter.

### Polymer Support

Design of the polymer support structure is critical to optimal FO membrane performance for the reasons discussed above. The following polymer support properties are of importance to affect maximum performance in combination with the IPC fabric support:

Minimize quantity of polymer deposited in the casting process while allowing sufficient polymer solution penetration to provide adequate mechanical attachment—this minimizes the support thickness based on the IPC fabric properties;

Minimize the penetration depth of the polymer solution into IPC by adapting the polymer solution or regulating the casting process parameters. Polymer solution can be tuned appropriately for this application by carefully controlling the solution parameters such as viscosity and surface tension. Regulation of process parameters include, but not limited to casting speed variation and controlled air flow through IPC. Casting speed influences the timing of the onset of coagulation which in turn locks the polymer depth of penetration into IPC. Controlled air flow through the IPC channel would also result in regulating the depth of penetration of the polymer as air flow would counteract the viscous flow of the polymer;

Maximize Young's modulus—this minimizes the degree of polymer solution penetration in order to provide adequate mechanical attachment and consequently minimizes the support thickness required;

Minimize the sponge layer directly beneath the active layer—maximizes porosity; and

Minimize pore tortuosity by formulating for macrovoids that span the support layer thickness.

### Materials, Casting Processes and Post-Processes

Some of the materials, casting processes and post-processes will now be briefly described.

### Polymers

The polymer support portion of the membrane that is placed on the support fabric (the IPC spacer fabric) can be based on a range of materials. The polymer support portion of the membrane acts as a scaffold for the active layer of the membrane. Examples of polymers useful in the support portion of the membrane include but are not limited to the following: hydroxylpropylcellulose, carboxymethylcellulose, polyvinylpyrrolidone, cross-linked polyvinylpyrrolidone, polyvinylalcohol, polyvinylacetate, polyethyleneoxide, polyvinylchloride, polysulfone, polyethersulfone, polyarylsulfone, polyphenylene sulphide, polyurethane, polyvinylidene fluoride, polyimide, polyacrylonitrile, cellulose acetate, cellulose triacetate, cellulose acetate propionate, cellulose butyrate, cellulose acetate propionate, cellulose diacetate, cellulose dibutyrate, cellulose tributyrate, polyvinyl alcohol (PVA), sulfonated PS, sulfonated PES, sulfonated polyetherketone, polyetheretherketone, sulfonated polyimides, sulfonated styrenic block copolymers and combinations thereof.

### Pore Formers

Pore forming materials added to the polymer solution prior to casting are known to change the pore size and pore size distribution of the resulting membranes. The following are examples of such pore formers: mono- and dialkyl ethers of ethylene glycol and derivatives thereof; mono- and dialkyl ethers of diethylene glycol and derivatives thereof; lower molecular weight monohydric alcohols such as methanol, ethanol, N-propanol, isopropanol, N-butanol and 2-butanol; water-soluble polymers such as polyethylene glycol and polyvinyl pyrrolidone (PVP); inorganic salts such as LiCl, LiBr, LiNO and MgCl₂ and 3 Mg(ClO₄)₂; organic acids and organic acid salts, such as maleic acid, lactic acid and citric acid; mineral salts; amides and other polymers.

Mixtures of two or more of the aforementioned pore-forming materials can also be employed, if desired.

The aforementioned pore-forming materials will be used in amounts suitably ranging from about 2 to about 30% by weight (wt %), and preferably in an amount of about 15% by weight (wt %), based on the weight of the polymer in the casting solution.

Still another excellent pore-forming material is a minor amount of water, e.g., in the range of about 0 to about 5 by weight (wt %), preferably from about 0.5 to about 4 by weight (wt %), based on the weight of the pore-forming material in the casting solution.

It is also well-known that the pore size can be varied by means of a different temperature.

### Membrane Formation Process

Specifically, to create the composite support structure, the immersion precipitation process, such as described in U.S. Pat. No. 3,133,132 (which is hereby incorporated by reference), may be employed.

First, a membrane polymeric material (e.g., a hydrophilic polymer (e.g., polysulfone (PS), polyethersulfone (PES), etc.)) is dissolved in water-soluble solvent (for example, in a non-aqueous solvent, such as N-methylpyrrolidone and the like) system to form a viscous solution.

Next, a thin layer of the viscous solution is metered onto both sides of the IPC support fabric. After air drying for a short time if needed (e.g., under an air knife), the liquid pre-membrane composite may then be quickly immersed into a coagulation bath (e.g., water bath) to solidify the viscous polymer solution. The coagulation bath causes the membrane components to coagulate and form the appropriate membrane characteristics (e.g., porosity, hydrophilic nature, asymmetric nature, and the like). Thus, the water contact causes the polymer in solution to become unstable and a layer of dense polymer precipitates on the surface very quickly. This layer acts as an impediment to water penetration further into the solution so the polymer beneath the dense layer precipitates much more slowly and forms a loose, porous matrix around the embedded fabric

Then, after the entire polymer is condensed from the viscous solution, the membrane can be washed and heat treated. Thus, the immersion/precipitation process may form a porous composite support layer with macro-, ultra-, and/or nano-filtration sized pores. The composite support layer has its porosity controlled by both casting parameters (time, temperature, standard techniques, and the like) and by the choices of formulation components (solvent, ratio of solids of polymeric material to solvent solution, and the like).

To add the rejection layer onto the composite support layer (it is a thin coating of a hydrophilic polymer which will become the dense rejection layer), various options are available. The composite support layer may be coated with a pre-formed polymer (e.g., polysulfone (PS), polyethersulfone (PES), polyvinyl alcohol (PVA), polyacrylo nitrile, sulfonated PS, sulfonated PES, sulfonated polyetherketone, polyetheretherketone, sulfonated polyimides, sulfonated styrenic block copolymer such as those available from Kraton, and the like). The coating of the composite support layer may be accomplished by a variety of processes, e.g., using an extrusion head process, a knife-over process, or a float coating process.

Alternatively, a polymer such as polyamide may be polymerized in-situ on the composite support layer. For the in-situ interfacial polymerization of polyamide, the composite support layer is first soaked in an aqueous solution of m-phenylenediamine (m-PDA). Excess m-PDA is removed from the surface and a solution of trimesoyl chloride (TMC) in hexane is applied to the top surface of the amine-soaked composite support layer. Interfacial polymerization occurs to yield a thin polyamide rejection layer on the composite support layer. Coatings of thicknesses about one (1) micron or less (e.g., 0.2 micron) are readily achievable.

Thus, the result is the formation of a two-layered TFC membrane on either side of the IPC support. It is a thin, mechanically robust membrane that yields high water flux values. The thickness of this membrane may be about 80 microns or less (versus the 180 micron or more thickness of a conventional three-layered membrane).

The very thin rejection layer deposited onto the composite layer is the portion of the membrane which allows the passage of water while blocking other species. The porous composite support layer acts as a support for the rejection layer. The composite support layer is needed because on its own a thin rejection layer would lack the mechanical strength and cohesion to be of any practical use. In an FO process, water transport occurs through the holes of the composite support layer, because the embedded fabric fibers and the pores of the polymer do not offer significant lateral resistance (that is, the embedded fabric fibers do not significantly impede water getting to surface of membrane).

In an RO process, the flux of the membrane is overwhelmingly dependent on the thickness, composition and morphology of the dense or skin layer, so there has been little impetus to optimize the performance of the porous layer. However in FO and PRO, water is drawn through the membrane by a difference in dissolved species concentration across the dense layer. If the higher concentration is on the porous layer side of the dense layer, the water being pulled through the dense layer carries the dissolved species in the porous layer away from the dense layer. For the process to continue, the dissolved species must diffuse back through the porous layer to the dense layer. Likewise, if the higher concentration is on the open side of the dense layer, as water is extracted from the fluids in the porous layer, the concentration of dissolved species in the porous layer will increase. For the process to continue they must diffuse out of the back of the membrane into the feed solution.

Many additional implementations are possible.

Optionally, prior to casting, hydrophilizing agents (e.g., PVP) and strengthening agents (e.g., agents to improve pliability and reduce brittleness, such as methanol, glycerol, ethanol, and the like for example) may be included/mixed in the viscous solution (membrane polymeric material dissolved in water-soluble solvent).

For the exemplary purposes of this disclosure, in another implementation the resulting two-layered TFC membrane can be further treated with a hydrophilizing agent to increase water wettability (to make the membrane more hydrophilic). An example of a post-treatment method to improve water wettability employs polydopamine, polyvinylpyrrolidone (PVP), PVOH, and the like.

Other post-membrane formation steps that may also be employed to optimize the performance of the resulting membrane, such as thermal treatments, chemical treatments (e.g. NaOCl followed by NaHSO₃) and surface modifications to improve anti-fouling properties, water flux, salt rejection, long-term performance, and the like.

### Specifications and Materials

It will be understood that implementations are not limited to the specific components disclosed herein, as virtually any components consistent with the intended operation of an IPC-based membrane may be utilized. Accordingly, for example, although particular components and so forth, are disclosed, such components may comprise any shape, size, style, type, model, version, class, grade, measurement, concentration, material, weight, quantity, and/or the like consistent with the intended operation of an IPC-based membrane implementation. Implementations are not limited to uses of any specific components, provided that the components selected are consistent with the intended operation of an IPC-based membrane implementation.

Accordingly, the components defining any IPC-based membrane implementation may be formed of any of many different types of materials or combinations thereof that can readily be formed into shaped objects provided that the components selected are consistent with the intended operation of an IPC-based membrane implementation. For the exemplary purposes of this disclosure, the membrane implementations may be constructed of a wide variety of materials and have a wide variety of operating characteristics. For example, the membranes may be semi-permeable, meaning that they pass substantially exclusively the components that are desired from the solution of higher concentration to the solution of lower concentration, for example, passing water from a more dilute solution to a more concentrated solution.

### Use

Implementations of a membrane according to the invention are particularly useful in various FO/water treatment applications. However, implementations are not limited to these applications. Implementations may also be used with similar results in a variety of other applications.

In places where the description above refers to particular implementations, it should be readily apparent that a number of modifications may be made without departing from the spirit thereof and that these implementations may be alternatively applied. The presently disclosed implementations are, therefore, to be considered in all respects as illustrative and not restrictive.

There are many features of method implementations disclosed herein that lead to optimal FO membrane performance, of which one, a plurality, or all features or steps may be used in any particular implementation. In the following description, it is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

1. A forward osmosis membrane structure comprising
a support comprising IPC fabric that is comprised of
an upper fabric layer having an inner surface and an outer surface;
a lower fabric layer having an inner surface and an outer surface; and
monofilament threads disposed between said upper fabric layer and said lower fabric layer and linking the upper fabric layer to the lower fabric layer;
wherein the outer surfaces of the upper and lower fabric layers are provided with a forward osmosis polymer layer.

2. The forward osmosis structure of claim 1, wherein the IPC fabric is a knitted fabric.

3. The forward osmosis structure of claim 1, wherein the IPC fabric is comprised of a material selected from the group consisting of: polyester, nylon, polyamide, polyphenylene sulphide, polyethylene and polypropylene.

4. The forward osmosis structure of claim 1, wherein the threads define macrovoids.

5. The forward osmosis structure of claim 1, wherein the IPC fabric is comprised of microfilament threads having a diameter in the range of about 50 to about 500 microns.

6. The forward osmosis structure of claim 5, wherein the IPC fabric is comprised of microfilament threads having a diameter in the range of about 60 to about 150 microns.

7. A method for producing a forward osmosis membrane structure, comprising the steps of:
(a) providing a support comprising an IPC fabric that is comprised of
an upper fabric layer having an inner surface and an outer surface;
a lower fabric layer having an inner surface and an outer surface; and
monofilament threads disposed between said upper fabric layer and said lower fabric layer and linking the upper fabric layer to the lower fabric layer;
(b) embedding a forward osmosis membrane on the outer surfaces of the upper layer and the lower layer.

8. A method of performing forward osmosis using the forward osmosis membrane structure of claim 1.
